(19) United States
(12) Patent Application Publication
(10) Pub. No.: US 2026/0244079 A1
(43) Pub. Date: Aug. 20, 2026

(54) APERTURE MODULE AND CAMERA MODULE INCLUDING APERTURE MODULE

(71) Applicant: SAMSUNG ELECTRO-MECHANICS CO., LTD., Suwon-si (KR)

(72) Inventors: Bo Sung SEO, Suwon-si (KR); Nam Ju LEE, Suwon-si (KR); Jun Sup SHIN, Suwon-si (KR)

(73) Assignee: SAMSUNG ELECTRO-MECHANICS CO., LTD., Suwon-si (KR)

(21) Appl. No.: 19/535,546

(22) Filed: Feb. 10, 2026

(30) Foreign Application Priority Data
Feb. 18, 2025 (KR) 10-2025-0020787
Dec. 30, 2025 (KR) 10-2025-0213458

(51) Int. Cl. G03B 9/06; G03B 17/12

(52) U.S. Cl. CPC G03B 9/06; G03B 17/12

(57) ABSTRACT

An aperture module includes a plurality of blades disposed on a lens barrel, the plurality of blades forming an incident hole, a driving link on which a magnet is disposed, the driving link configured to be rotatable, and a coil disposed to oppose the magnet. The lens barrel has a first outer diameter and a second outer diameter, and a rotation axis of the driving link is disposed between the first outer diameter and the second outer diameter of the lens barrel.

### CROSS-REFERENCE TO RELATED APPLICATIONS

This application claims the benefit under 35 USC 119(a) of Korean Patent Application Nos. 10-2025-0020787 filed on February 18, 2025, and 10-2025-0213458 filed on December 30, 2025, in the Korean Intellectual Property Office, the entire disclosures of which are incorporated herein by reference for all purposes.

### BACKGROUND

### 1. Field

The present disclosure relates to an aperture module and a camera module including the same.

### 2. Description of the Background

Cameras have been standardly provided in portable electronic devices such as smartphones, tablet PCs, and laptop computers.

Recently, as competition for product differentiation of portable electronic devices has intensified, cases of applying digital camera functions to cameras of portable electronic devices have increased. Among these cases, there has been a growing demand for achieving effects such as bokeh or capturing bright and clear images by adjusting an amount of light through variable apertures.

In general, digital cameras may be driven to vary an amount of incident light according to image capturing conditions using a mechanical aperture. However, for camera modules applied to small-sized devices such as portable electronic devices, it may be difficult to adopt a mechanical aperture without any change due to structural characteristics and spatial limitations.

Accordingly, there is a need to develop an aperture having a small size and small thickness suitable for application in portable electronic devices.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an aperture module includes a plurality of blades disposed on a lens barrel, the plurality of blades forming an incident hole, a driving link on which a magnet is disposed, the driving link configured to be rotatable, and a coil disposed to oppose the magnet. The lens barrel has a first outer diameter and a second outer diameter. A rotation axis of the driving link is disposed between the first outer diameter and the second outer diameter of the lens barrel.

The plurality of blades may have rotation axes, and one blade, among the plurality of blades, may share a rotation axis with the driving link.

The rotation axes of the plurality of blades may be disposed between the first outer diameter and the second outer diameter of the lens barrel.

The first outer diameter of the lens barrel may be a minimum outer diameter of the lens barrel, and the second outer diameter of the lens barrel may be a maximum outer diameter of the lens barrel.

The plurality of blades may include three or more blades.

The blade sharing the rotation axis with the driving link, among the plurality of blades, may be integrally formed with the driving link.

The plurality of blades may include a first blade and a second blade having rotation axes different from that of the driving link, and a third blade having a rotation axis the same as that of the driving link, and the third blade may be coupled to the first blade and the second blade.

The first blade and the second blade may include guide slits penetrating through the first blade and the second blade in the optical axis direction, respectively, and the third blade may have guide protrusions protruding in the optical axis direction, the guide protrusions may be disposed to respectively penetrate through the guide slits.

The plurality of blades may further include an auxiliary blade disposed to overlap the first blade, the second blade, and the third blade in the optical axis direction, and the auxiliary blade may include coupling holes to which the guide protrusions disposed to penetrate through the guide slits may be coupled.

The driving link may extend in an optical axis direction, and may be disposed at a distance from the lens barrel in a direction perpendicular to an optical axis.

At least a portion of the driving link may be bent along a shape of the lens barrel.

The aperture module may further include a base to which the plurality of blades and the driving link may be coupled. The base may be coupled to the lens barrel.

The lens barrel may have a minimum outer diameter on an object side thereof, and the base may have a ring shape, and may be coupled to an outer circumferential surface having the minimum outer diameter of the lens barrel.

A camera module may include a housing, a carrier accommodated in the housing, the carrier may be configured to move in an optical axis direction, the lens barrel including a plurality of lenses, the lens barrel may be coupled to the carrier, and the aperture module, wherein the coil may be disposed on the housing.

The driving link may extend in the optical axis direction along the lens barrel, and the magnet may be disposed between the carrier and the housing to oppose the coil in a direction perpendicular to an optical axis.

The driving link may be disposed to be spaced apart from the lens barrel and the carrier in the direction perpendicular to the optical axis.

The carrier may include a groove on an external surface thereof, and the magnet may be disposed in the groove.

The camera module may further include a ball bearing disposed between the carrier and the magnet.

The camera module may further include a focus adjustment magnet disposed on the carrier, and a focus adjustment coil disposed on the housing to oppose the focus adjustment magnet.

The plurality of blades may have rotation axes, the rotation axes of the plurality of blades may be disposed between a first outer diameter and a second outer diameter of the lens barrel, and one blade, among the plurality of blades, may share a rotation axis with the driving link.

The camera module may further include a cap coupled to the lens barrel configured to cover the plurality of blades.

In another general aspect, an aperture module includes a plurality of blades forming an incident hole, a driving link extending in an optical axis direction, a magnet disposed on the driving link, and a coil disposed to oppose the magnet. The plurality of blades and the driving link are configured to rotate about rotation axes by driving force generated by the magnet and the coil. One blade, among the plurality of blades, shares a rotation axis with the driving link.

The plurality of blades and the driving link may be disposed on a lens barrel, and the rotation axes of the plurality of blades and the driving link may be disposed between a first outer diameter and a second outer diameter of the lens barrel.

The magnet and the coil may be disposed to oppose each other in a first direction perpendicular to the optical axis direction, and may generate driving force in a second direction perpendicular to both the optical axis direction and the first direction.

The driving link may be disposed at a distance from the lens barrel in a direction perpendicular to an optical axis.

In another general aspect, an aperture module includes a plurality of blades each disposed on a separate rotation axis, and forming an incident hole, and a driving link configured to be rotatable and sharing a same rotation axis as a blade of the plurality of blades, wherein the blade sharing the same rotation axis as the driving link is coupled to at least a first blade and a second blade of the plurality of blades, and wherein the plurality of blades are configured to rotate in response to rotation of the driving link.

The aperture module may further include a magnet disposed on the driving link, and a coil disposed to oppose the magnet, wherein the magnet and the coil may be configured to generate a driving force to rotate the driving link.

A lens barrel may have a first outer diameter and a second outer diameter, and the rotation axis of the driving link may be disposed between the first outer diameter and the second outer diameter of the lens barrel.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIG. 2 is a schematic exploded perspective view of a camera module according to an example embodiment of the present disclosure.

FIG. 3 is a plan view of a state (cap removed) in which an aperture module is coupled to a camera module according to an example embodiment of the present disclosure.

FIG. 4 is an exploded perspective view of an aperture module according to an example embodiment of the present disclosure.

FIG. 5 is an exploded view of a base and a lens barrel according to an example embodiment of the present disclosure.

FIG. 6A is a perspective view (first state-maximum incident hole) of a plurality of blades according to an example embodiment of the present disclosure.

FIG. 6B is a perspective view (second state-minimum incident hole) of a plurality of blades according to an example embodiment of the present disclosure.

FIG. 7 is a cross-sectional view taken along line I-I’ of FIG. 1.

FIG. 8 is an enlarged view of region A of FIG. 7.

FIG. 9 is a view of addition of a ball member to FIG. 8.

FIG. 10 is a view of a plurality of blades according to an example embodiment of the present disclosure.

FIG. 11 is a bottom perspective view of a state in which a plurality of blades are coupled to each other according to an example embodiment of the present disclosure.

FIG. 12 is an exploded perspective view of a plurality of blades according to another example embodiment of the present disclosure.

FIG. 13A is a plan view (first state-maximum incident hole) of a state in which a plurality of blades are coupled to a lens barrel according to another example embodiment of the present disclosure.

FIG. 13B is a plan view (second state-minimum incident hole) of a state in which a plurality of blades are coupled to a lens barrel according to another example embodiment of the present disclosure.

FIG. 14 is an exploded perspective view of a lens driving unit according to an example embodiment of the present disclosure.

FIG. 15 is a side view of a lens driving unit according to an example embodiment of the present disclosure.

FIG. 16 is a plan view of a lens driving unit according to an example embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide an aperture module having a small size and small thickness applicable to a camera of a portable electronic device, and a camera module including the same.

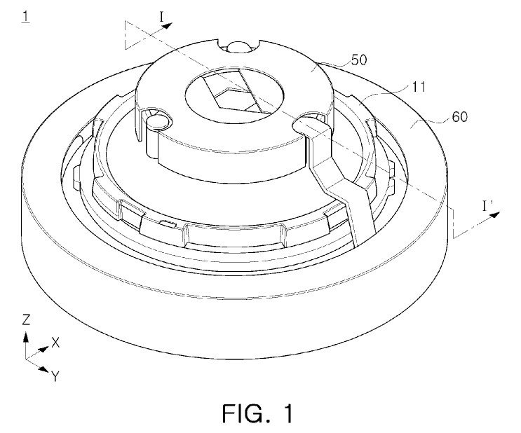

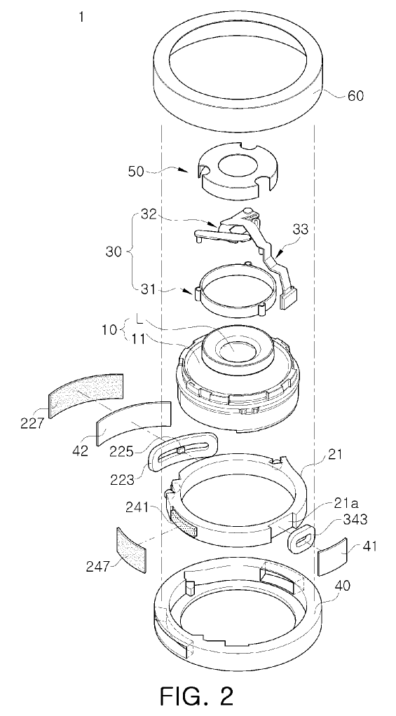

FIG. 1 is a perspective view of a camera module according to an example embodiment of the present disclosure. FIG. 2 is a schematic exploded perspective view of a camera module according to an example embodiment of the present disclosure.

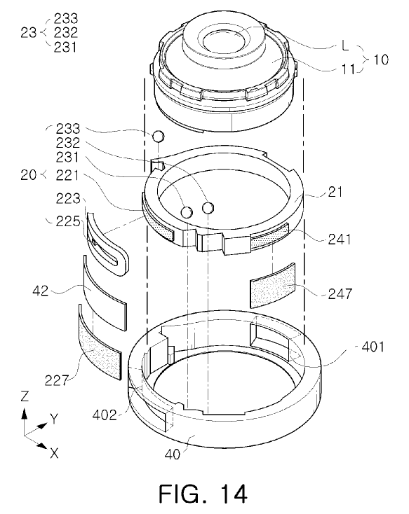

According to an example embodiment of the present disclosure, a camera module 1 may include a lens module 10, a lens driving unit 20 (FIG. 14) driving the lens module 10, and an aperture module 30 adjusting an amount of light incident on the camera module 1. Although not illustrated in the drawings, the camera module 1 may include an image sensor converting light incident on the camera module 1 into an electrical signal. Light incident on the camera module 1 may ultimately reach the image sensor.

The lens module 10 may include a plurality of lenses L and a lens barrel 11 on which the plurality of lenses L are mounted. The plurality of lenses L may be mounted in the lens barrel 11 in an optical axis direction (Z-axis direction).

The lens driving unit 20 may be configured to move the lens module 10 to adjust focus or stabilize an image. In the embodiment illustrated in FIG. 2, the lens driving unit 20 may be configured to move the lens module 10 in the optical axis direction (Z-axis direction) to adjust focus. However, in another example embodiment, the lens driving unit 20 may include both an auto focus unit (AFU) moving the lens module 10 in the optical axis direction (Z-axis direction), and an optical image stabilization (OIS) unit moving the lens module 10 in a direction perpendicular to an optical axis (Z-axis). A detailed description of the lens driving unit 20 will be provided below.

The aperture module 30 may be disposed on an object side of the lens module 10 to adjust an amount of light incident on the camera module 1. In an example embodiment, the aperture module 30 may adjust an amount of light by changing a size of an incident hole.

The camera module 1 may include a housing 40 and a shield can 60, forming the exterior of the camera module 1. The lens module 10, the lens driving unit 20, and the aperture module 30 may be disposed in a space defined by the housing 40, and the shield can 60 may be coupled to the housing 40.

In addition, the camera module 1 may further include a cap 50 coupled to the lens module 10 to cover the aperture module 30.

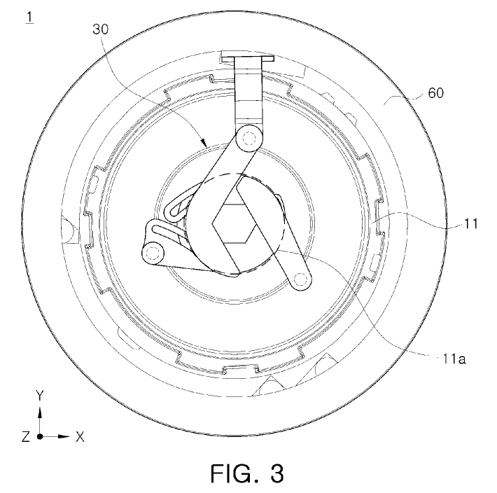

FIG. 3 is a plan view of a state (cap removed) in which an aperture module is coupled to a camera module according to an example embodiment of the present disclosure.

Referring further to FIG. 3, the aperture module 30 may be coupled to the lens barrel 11, and may adjust an amount of light incident on the camera module 1.

In an example embodiment, the aperture module 30 may include a plurality of blades 32 forming an incident hole. The plurality of blades 32 may be disposed on an object side of a lens barrel opening portion 11a through which light is incident, and may adjust an amount of light incident on the camera module 1 by adjusting a size of the incident hole. An operation of adjusting, by the plurality of blades 32, the size of the incident hole may be implemented as a continuous motion.

The aperture module 30 may be provided to be coupled to the lens barrel 11. Accordingly, when the lens module 10 is moved by the lens driving unit 20, the aperture module 30 may also move together with the lens module 10.

Hereinafter, the aperture module 30 according to an example embodiment of the present disclosure will be described in more detail.

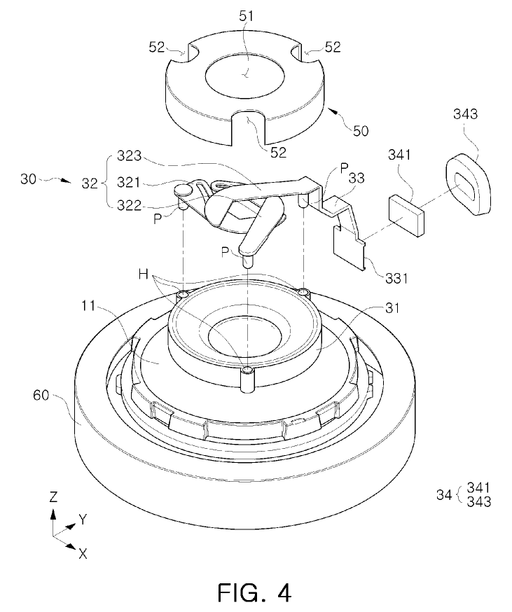

FIG. 4 is an exploded perspective view of an aperture module according to an example embodiment of the present disclosure.

Referring to FIG. 4, the aperture module 30 according to an example embodiment of the present disclosure may include a base 31, a plurality of blades 32, a driving link 33, and an aperture driving unit 34.

According to an example embodiment of the present disclosure, the aperture module 30 may include a base 31 coupled to the lens module 10. In an example embodiment, the base 31 may have a ring shape, and may be fitted to an outer circumferential surface of the lens barrel 11.

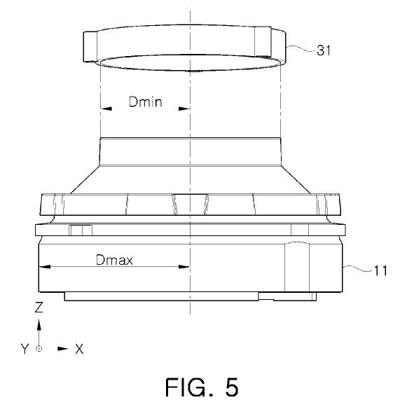

FIG. 5 is an exploded view of a base and a lens barrel according to an example embodiment of the present disclosure.

Referring to FIG. 5, the lens barrel 11 may have a varying outer diameter in certain sections thereof. Specifically, the plurality of lenses L, mounted on the inside of the lens barrel 11, may tend to have an increasing outer diameter from an object side thereof toward an image side thereof, and the lens barrel 11 may have a shape corresponding to such a lens arrangement.

Accordingly, the lens barrel 11 may have a minimum outer diameter (Dmin) on an object side thereof, and a maximum outer diameter (Dmax) on an image side thereof, and the base 31 may be fitted to the outer circumferential surface of the lens barrel 11 having the minimum outer diameter (Dmin).

The plurality of blades 32 and the driving link 33 may be coupled to the base 31. In an example embodiment, the base 31 may include a plurality of coupling holes H to which the plurality of blades 32 and/or the driving link 33 are coupled. The plurality of coupling holes H may have a length in the optical axis direction (Z-axis direction), and may be disposed to be spaced apart from each other at a substantially equal distance in a circumferential direction of a circle centered on the optical axis (Z-axis) and having an arbitrary radius, in an example embodiment, in a circumferential direction of the ring-shaped base 31.

In another example embodiment of the present disclosure, the base 31 may be omitted. In this case, the lens barrel 11 may replace the base 31. For example, the plurality of coupling holes H to which the plurality of blades 32 and the driving link 33 are coupled may be formed in the lens barrel 11, and the plurality of blades 32 and the driving link 33 may be directly coupled to the lens barrel 11.

According to an example embodiment of the present disclosure, the aperture module 30 may include a plurality of blades 32 disposed on the object side of the lens barrel opening portion 11a.

The plurality of blades 32 may form an incident hole. In an example embodiment, the plurality of blades 32 may include three blades (hereinafter, a first blade 321, a second blade 322, and a third blade 323).

However, the number of blades 32 is not limited to three. In another example embodiment, the plurality of blades 32 may include four or more blades. An increase in the number of blades may allow for more precise adjustment of the size of the incident hole, but driving may be unstable due to interference between adjacent blades. Accordingly, the number of blades may be appropriately selected in consideration of a size of the camera module 1 or the like.

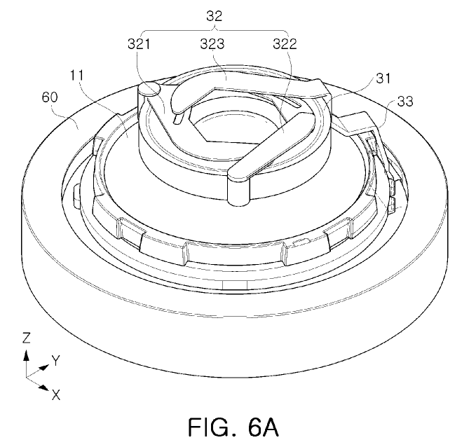

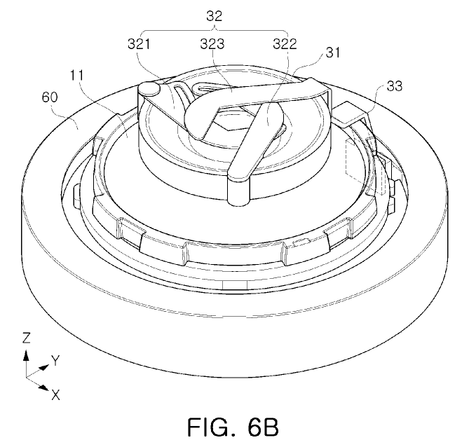

FIG. 6A is a perspective view (first state-maximum incident hole) of a plurality of blades according to an example embodiment of the present disclosure. FIG. 6B is a perspective view (second state-minimum incident hole) of a plurality of blades according to an example embodiment of the present disclosure.

The plurality of blades 32 may be disposed to overlap each other in the optical axis direction (Z-axis direction). In an example embodiment, the first blade 321, the second blade 322, and the third blade 323 may be sequentially stacked in the optical axis direction (Z-axis direction) from the lens barrel opening portion 11a, and may overlap each other in the optical axis direction (Z-axis direction).

The plurality of blades 32 may be disposed to overlap each other in the optical axis direction (Z-axis direction) to define an incident hole. The plurality of blades 32 may rotate by the aperture driving unit 34 to change positions thereof, and a size of the incident hole may be adjusted according to the positions of the plurality of blades 32.

Referring to FIGS. 6A and 6B, when the plurality of blades 32 overlap each other around the optical axis (Z-axis), the incident hole may have a minimum size. When the plurality of blades 32 overlap each other around the lens barrel opening portion 11a, the incident hole may have a maximum size. Generally, the plurality of blades 32 may operate in a state illustrated in FIG. 6B in a bright environment, and may operate in a state illustrated in FIG. 6A in a dark environment.

In an example embodiment, the incident hole formed by the plurality of blades 32 may have an approximately hexagonal shape. Accordingly, the first blade 321, the second blade 322, and the third blade 323 may each have a bent form to form two sides.

The plurality of blades 32 may be supported by the base 31 and driven to rotate.

In an example embodiment, the plurality of blades 32 may include coupling protrusions P protruding in the optical axis direction (Z-axis direction). The coupling protrusions P may be formed at respective one ends of the plurality of blades 32, and may be inserted into the plurality of coupling holes H formed in the base 31. As a result, the plurality of blades 32 may be supported by the base 31.

The number of the plurality of coupling holes H may be provided to correspond to the number of the plurality of blades 32. The first blade 321, the second blade 322, and the third blade 323 may be inserted into different coupling holes H, respectively.

In a state in which the plurality of blades 32 are supported by the base 31, the plurality of blades 32 may rotate using respective coupling protrusions P as rotation axes RA by driving force generated by the aperture driving unit 34. The rotation axes RA may be parallel to the optical axis (Z-axis).

The rotation axes RA of the plurality of blades 32 may be spaced apart from each other in a circumferential direction of a circle centered on the optical axis (Z-axis) and having an arbitrary radius, in an example embodiment, in a circumferential direction of the ring-shaped base 31. In an example embodiment of the present disclosure, the lens barrel 11 may have a first outer diameter and a second outer diameter, and the rotation axes RA of the plurality of blades 32 may be positioned between the first outer diameter and the second outer diameter. Specifically, the first outer diameter may be a minimum outer diameter (Dmin) of the lens barrel 11, and the second outer diameter may be a maximum outer diameter (Dmax) of the lens barrel 11. The rotation axes RA of the plurality of blades 32 may be positioned between the minimum outer diameter (Dmin) and the maximum outer diameter (Dmax) of the lens barrel 11. That is, a distance from the optical axis (Z-axis) to the rotation axes RA of the plurality of blades 32 in a direction, perpendicular to the optical axis (Z-axis), may be greater than the first outer diameter and less than the second outer diameter, specifically, may be greater than the minimum outer diameter (Dmin) and less than the maximum outer diameter (Dmax) of the lens barrel 11.

The rotation axes RA of the plurality of blades 32 may be implemented in other forms. For example, the plurality of blades 32 may include through-holes (not illustrated) instead of the coupling protrusions P, and the aperture module 30 may include coupling pins (not illustrated) coupled to the through-holes of the plurality of blades 32 and the coupling holes H of the base 31. The through-holes of the plurality of blades 32 and the coupling holes H of the base 31 may be disposed to overlap each other in the optical axis direction (Z-axis direction), and the coupling pins may have a length in the optical axis direction (Z-axis direction) so as to simultaneously penetrate through both the through-holes and coupling holes H. The plurality of blades 32 may rotate using the coupling pins as the rotation axes RA by driving force generated by the aperture driving unit 34. In the presented example embodiments, both the coupling protrusions P and the coupling pins may be in the form of a shaft having a length in the optical axis direction (Z-axis direction).

According to an example embodiment of the present disclosure, the aperture module 30 may include a driving link 33 transmitting driving force to the plurality of blades 32.

The driving link 33 may be supported by the base 31 in the same manner as the plurality of blades 32, and may share a rotation axis RA with one of the plurality of blades 32 so as to transmit driving force to the plurality of blades 32. That is, the rotation axis RA of the driving link 33 may also be positioned between the first outer diameter and the second outer diameter of the lens barrel 11, specifically, between the minimum outer diameter (Dmin) and the maximum outer diameter (Dmax) of the lens barrel 11.

In an example embodiment, the driving link 33 may be integrally formed with one of the plurality of blades 32. Referring to FIG. 4, based on the coupling protrusions P, a portion overlapping the lens barrel opening portion 11a in the optical axis direction (Z-axis direction) may be the third blade 323, and a portion overlapping the lens barrel 11 in a direction perpendicular to the optical axis (Z-axis) may be the driving link 33.

In another example embodiment, the driving link 33 may be provided as a separate member from the plurality of blades 32. In this case, to allow the driving link 33 to share the rotation axis RA with one of the plurality of blades 32, the driving link 33 and the plurality of blades 32 may include through-holes, and coupling pins may be coupled to the through-hole of the driving link 33, the through-holes of the plurality of blades 32, and the coupling holes H of the base 31. The description of the through-holes and the coupling pins is replaced with the above description.

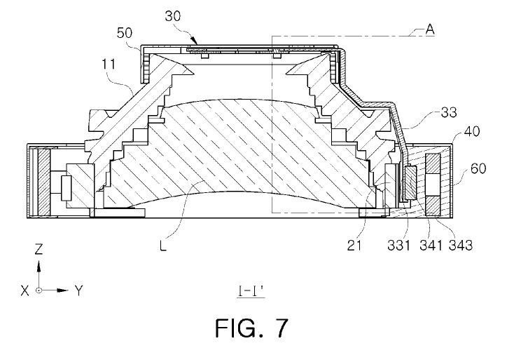

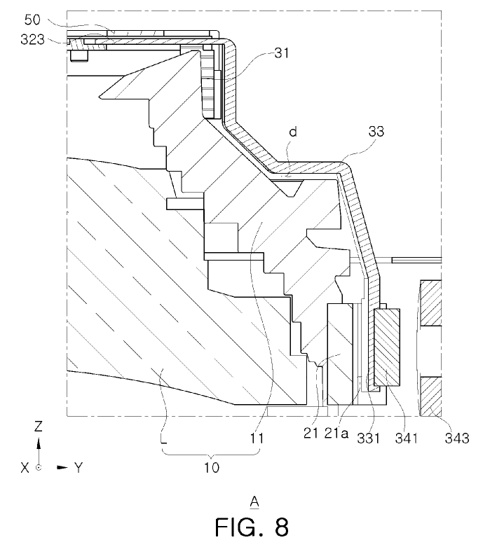

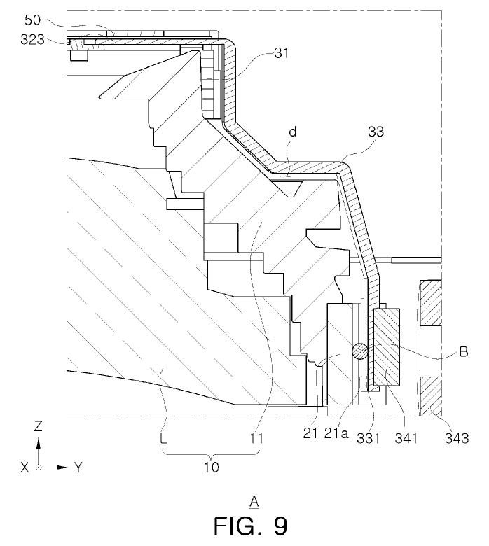

FIG. 7 is a cross-sectional view taken along line I-I’ of FIG. 1. FIG. 8 is an enlarged view of region A of FIG. 7. FIG. 9 is a view of addition of a ball member to FIG. 8.

The driving link 33 may be formed to extend in the optical axis direction (Z-axis direction), and may be disposed to overlap the lens barrel 11 in a direction, perpendicular to the optical axis (Z-axis). In this case, a distance d may be provided between the driving link 33 and the lens barrel 11 in a direction perpendicular to the optical axis (Z-axis).

In an example embodiment, the lens barrel 11 may have a shape having an outer diameter varying in the optical axis (Z-axis direction), and the driving link 33 may have a shape corresponding to that of the outer circumferential surface of the lens barrel 11. The driving link 33 may be formed of a flexible material, and at least a portion of the driving link 33 may be bent.

Referring to FIG. 7, a lower end of the lens barrel 11 may be coupled to a carrier 21, and the lens barrel 11 and the carrier 21 may be accommodated in the housing 40. The driving link 33 may extend in the optical axis direction (Z-axis direction) along the lens barrel 11 up to a height

opposing the housing 40. Accordingly, one end of the driving link 33 may be disposed on the outside of the carrier 21, coupled to the lower end of the lens barrel 11.

An aperture driving magnet 341 may be disposed at the one end of the driving link 33. The one end of the driving link 33 may include a magnet mounting portion 331 on which the aperture driving magnet 341 is mounted.

The magnet mounting portion 331 may be formed to have an area equal to or greater than that of one surface of the aperture driving magnet 341, mounted on the magnet mounting portion 331.

In an example embodiment, the driving link 33 may be formed of a material including metal. In this case, the magnet mounting portion 331 may serve as a back yoke, and may also efficiently dissipate heat generated in the aperture driving magnet 341.

Referring to FIG. 8, the driving link 33 may be disposed at a distance d from the outer circumferential surface of the lens barrel 11. In addition, the one end of the driving link 33 opposing the housing 40, that is, the magnet mounting portion 331, may be disposed at a distance d from an outer circumferential surface (or external surface) of the carrier 21. For example, a groove 21a may be formed on the outer circumferential surface of the carrier 21, and the magnet mounting portion 331 may be positioned in the groove and disposed at the distance d from the outer circumferential surface of the carrier 21. Movement of the driving link 33 may not interfere with the lens barrel 11 and the carrier 21.

As illustrated in FIG. 9, one or more ball bearings B may be additionally disposed between the magnet mounting portion 331 of the driving link 33 and the carrier 21. For example, the ball bearing B may be provided as a plurality of ball bearings B, and the plurality of ball bearings B may be disposed in a rotational direction of the driving link 33. The ball bearings B may maintain the distance d between the magnet mounting portion 331 and the carrier 21, and may support rotation of the driving link 33. In the present example embodiment, a magnetic member (not illustrated) may be disposed on the carrier 21.

According to an example embodiment of the present disclosure, the aperture module 30 may include an aperture driving unit 34 generating driving force to rotate the plurality of blades 32.

The aperture driving unit 34 may include an aperture driving magnet (hereinafter, a first driving magnet) 341 and an aperture driving coil (hereinafter, a first driving coil) 343.

The first driving magnet 341 and the first driving coil 343 may be disposed to oppose each other. The first driving magnet 341 may be disposed on the magnet mounting portion 331 of the driving link 33, and the first driving coil 343 may be disposed on the housing 40 to oppose the first driving magnet 341. The first driving magnet 341 and the first driving coil 343 may oppose each other in a direction perpendicular to the optical axis (Z-axis).

The first driving coil 343 may be mounted on a substrate (hereinafter, a first substrate) 41, and may be disposed on the housing 40 via the first substrate 41. In an example embodiment, the first substrate 41 may be disposed on an external surface of the housing 40, and the housing 40 may include a through-hole 401 penetrating through a side surface of the housing 40, such that the first driving coil 343 may oppose the first driving magnet 341 through the through-hole 401 (FIG. 14).

The first driving magnet 341 may be magnetized such that one surface thereof opposing the first driving coil 343 has an N-pole and an S-pole. For example, one surface of the first driving magnet 341, opposing the first driving coil 343, may sequentially include an N-pole, a neutral region, and an S-pole (or an S-pole, a neutral region, and an N-pole) in a length direction of the first driving magnet 341.

When power is applied to the first driving coil 343, the first driving magnet 341 and the first driving coil 343 may generate driving force in a direction perpendicular to a direction in which the first driving magnet 341 and the first driving coil 343 oppose each other. For example, the first driving magnet 341 and the first driving coil 343 may oppose each other in a first direction (Y-direction) perpendicular to the optical axis (Z-axis), and may generate driving force in a second direction (X-direction), perpendicular to the first direction (Y-direction). The second direction (X-direction) may be a direction perpendicular to both the optical axis (Z-axis) and the first direction (Y-direction).

The driving link 33 may rotate about the rotation axis RA by the driving force generated in the second direction (X-direction). In this case, the third blade 323 integrally formed with the driving link 33 may rotate together with the driving link 33. Even when the third blade 323 shares the rotation axis RA with the driving link 33, the third blade 323 may rotate together with the driving link 33.

Although not illustrated in the drawings, a position sensor (not illustrated) sensing a position of the driving link 33 in a direction, perpendicular to the optical axis (Z-axis), may be disposed on the first substrate 41. For example, the position sensor may be a Hall sensor, and may be disposed to oppose the first driving magnet 341.

The third blade 323 may be coupled to the first blade 321 and the second blade 322. Therefore, when the third blade 323 rotates, the first blade 321 and the second blade 322 may also rotate about respective rotation axes RA.

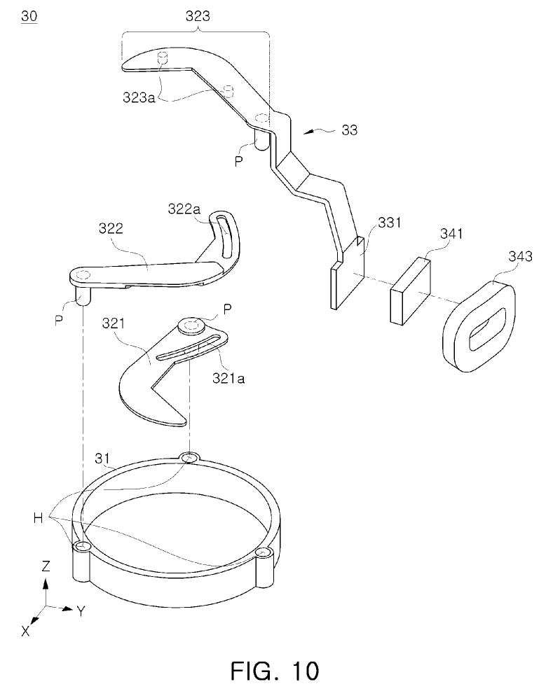

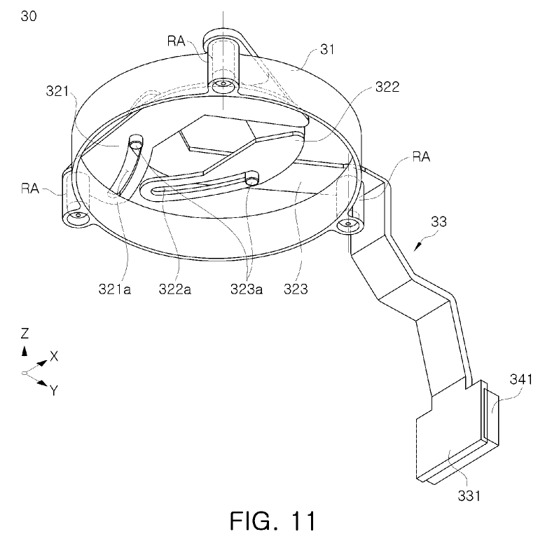

FIG. 10 is a view of a plurality of blades according to an example embodiment of the present disclosure. FIG. 11 is a bottom perspective view of a state in which a plurality of blades are coupled to each other according to an example embodiment of the present disclosure.

As described above, the first blade 321, the second blade 322, and the third blade 323 may be sequentially stacked from the lens barrel 11 in the optical axis direction (Z-axis direction).

Referring to FIGS. 10 and 11, the third blade 323 may include guide protrusions 323a protruding toward the first blade 321 and the second blade 322 in the optical axis direction (Z-axis direction), and the first blade 321 and the second blade 322 may include guide slits 321a and 322a penetrating therethrough in the optical axis direction (Z-axis direction).

In an example embodiment, the guide protrusions 323a may be formed at positions respectively overlapping a guide slit (hereinafter, a first guide slit) 321a of the first blade and a guide slit (hereinafter, a second guide slit) 322a of the second blade in the optical axis direction (Z-axis direction), and may be coupled to the first guide slit 321a and the second guide slit 322a. In an example embodiment, when positions at which coupling protrusions P are formed are referred to as one end of the first blade 321 and one end of the second blade 322, respectively, the first guide slit 321a may be formed at a position adjacent to the one end of the first blade 321, and the second guide slit 322a may be formed at a position adjacent to the other end of the second blade 322 from the one end of the second blade 322.

The first guide slit 321a and the second guide slit 322a may have a form extending in one direction. During rotation of the third blade 323, the guide protrusions 323a may move in extension directions of the first guide slit 321a and the second guide slit 322a in a state of being coupled to the first guide slit 321a and the second guide slit 322a.

While the guide protrusions 323a move in the extension directions of the first guide slit 321a and the second guide slit 322a, a size of an incident hole formed by the plurality of blades 32 may be changed. For example, when the guide protrusions 323a are positioned at one end of the first guide slit 321a and one end of the second guide slit 322a, respectively, the plurality of blades 32 may form a maximum incident hole. When the guide protrusions 323a are positioned at the other end of the first guide slit 321a and the other end of the second guide slit 322a, the plurality of blades 32 may form a minimum incident hole.

In another example embodiment, the plurality of blades 32 may further include an auxiliary blade 324 interconnecting the plurality of blades 32.

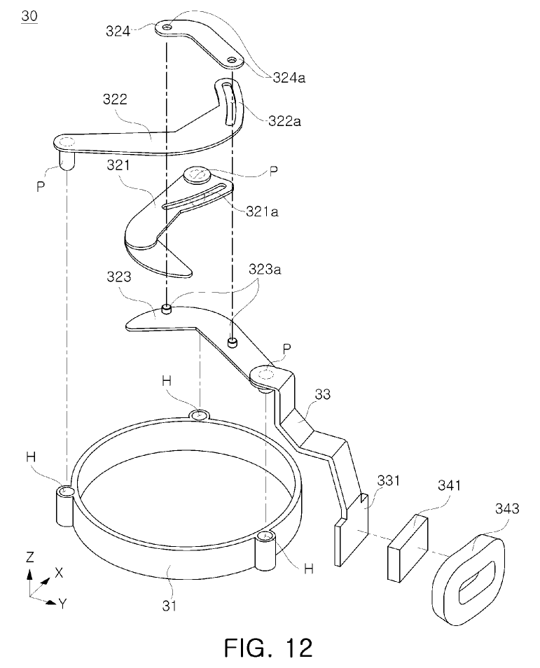

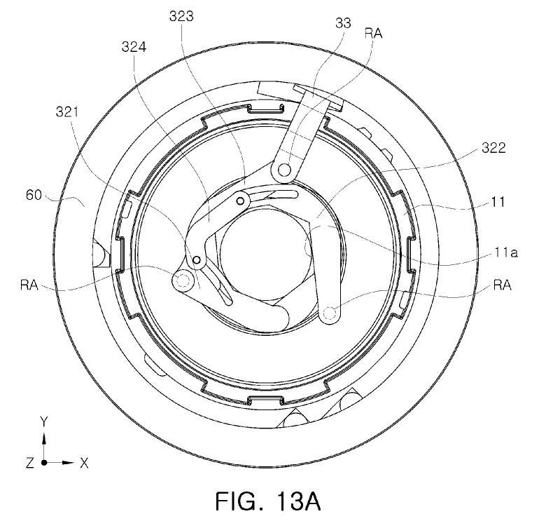

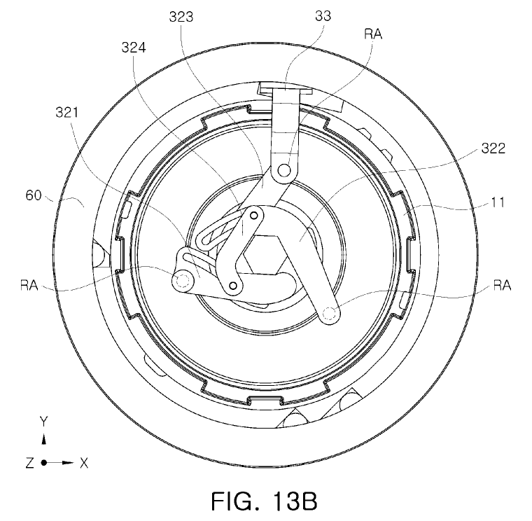

FIG. 12 is an exploded perspective view of a plurality of blades according to another example embodiment of the present disclosure. FIG. 13A is a plan view (first state-maximum incident hole) of a state in which a plurality of blades are coupled to a lens barrel according to another example embodiment of the present disclosure. FIG. 13B is a plan view (second state-minimum incident hole) of a state in which a plurality of blades are coupled to a lens barrel according to another example embodiment of the present disclosure.

Referring to FIG. 12, a first blade 321, a second blade 322, and a third blade 323 may be stacked on an object side in an optical axis direction (Z-axis direction), the third blade 323 may include guide protrusions 323a protruding toward the first blade 321 and the second blade 322 in the optical axis direction (Z-axis direction), and the first blade 321 and the second blade 322 may include a first guide slit 321a and a second guide slit 322a penetrating therethrough in the optical axis direction (Z-axis direction). The third blade 323 may be disposed on the object side of the lens barrel 11, the first blade 321 and the second blade 322 may be sequentially stacked in the object side direction from the third blade 323 along the optical axis direction (Z-axis direction).

The guide protrusions 323a may be coupled to the first guide slit 321a and the second guide slit 322a. In the above-described example embodiment, the guide protrusions 323a may be coupled to the first guide slit 321a and the second guide slit 322a from upper sides of the first blade 321 and the second blade 322. However, in the present example embodiment, the guide protrusions 323a may be coupled to the first guide slit 321a and the second guide slit 322a from lower sides of the first blade 321 and the second blade 322.

An auxiliary blade 324 may be disposed on the first blade 321, the second blade 322, and the third blade 323, and may be coupled to the guide protrusions 323a of the third blade 323. The auxiliary blade 324 may include coupling holes 324a penetrating through the auxiliary blade 324 in the optical axis direction (Z-axis direction) at both ends thereof in a length direction, respectively, and the guide protrusions 323a may pass through the first guide slit 321a and the second guide slit 322a and be coupled to and fixed to the coupling holes 324a.

Referring to FIGS. 13A and 13B, the auxiliary blade 324 may form a portion of an incident hole, together with the first blade 321, the second blade 322, and the third blade 323.

The example embodiment illustrated in FIGS. 10 and 11 may also include the auxiliary blade 324. In this case, the auxiliary blade 324 may be disposed below the first blade 321, the second blade 322, and the third blade 323.

According to an example embodiment of the present disclosure, a cap 50 may be disposed above the plurality of blades 32 to prevent separation of the plurality of blades 32. The cap 50 may be coupled to a lens barrel 11 to cover the plurality of blades 32.

The cap 50 may include a first through-hole 51 through which external light is incident. The incident hole, formed by the plurality of blades 32, may be exposed externally through the first through-hole 51. A size of the first through-hole 51 may be equal to or greater than a size of a maximum incident hole formed by the plurality of blades 32.

The cap 50 may include a plurality of second through-holes 52 formed in a circumferential direction of the cap 50. The second through-holes 52 may be formed at positions corresponding to those of rotation axes RA of the plurality of blades 32, and the rotation axes RA of the plurality of blades 32 may be exposed through the second through-holes 52. In addition, a driving link 33 may pass through the second through-holes 52 and be disposed on the outside of the lens barrel 11 and a carrier 21.

Although not illustrated in the drawings, a spacer (not illustrated) may be disposed between the cap 50 and the plurality of blades 32.

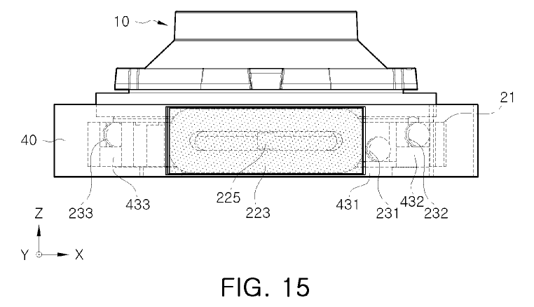

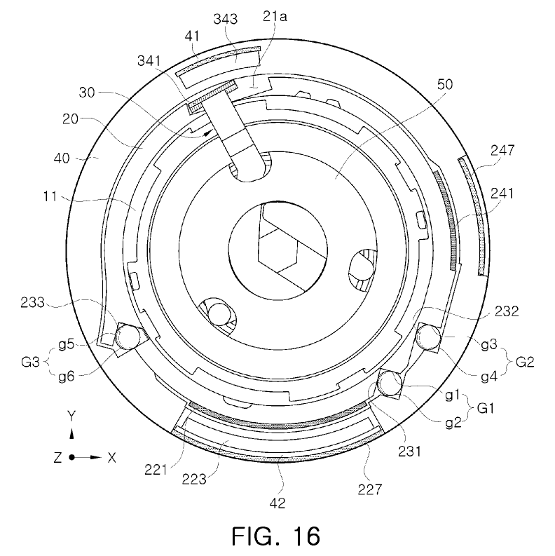

FIG. 14 is an exploded perspective view of a lens driving unit according to an example embodiment of the present disclosure. FIG. 15 is a side view of a lens driving unit according to an example embodiment of the present disclosure. FIG. 16 is a plan view of a lens driving unit according to an example embodiment of the present disclosure.

In FIGS. 14 to 16, components related to an aperture module 30 may be omitted.

According to an example embodiment of the present disclosure, a camera module 1 may include a lens driving unit 20 configured to move a lens module 10 in an optical axis direction (Z-axis direction).

Referring to FIG. 14, the lens driving unit 20 may include a carrier 21 coupled to the lens module 10, a magnet (hereinafter, a second driving magnet or a focus adjustment magnet) 221 and a coil (hereinafter, a second driving coil or a focus adjustment coil) 223 generating driving force in the optical axis direction (Z-axis direction), and a plurality of ball members 23 guiding movement of the lens module 10 in the optical axis direction (Z-axis direction).

In an example embodiment, the carrier 21 may have a cylindrical shape, and a side surface of the carrier 21 may be a curved surface.

The second driving magnet 221 may be disposed on an external surface of the carrier 21, and the second driving coil 223 may be disposed on an internal surface of the housing 40. The second driving magnet 221 and the second driving coil 223 may oppose each other in a direction perpendicular to an optical axis (Z-axis), for example, in a first direction (Y-direction).

The second driving coil 223 may be mounted on a substrate (hereinafter, a second substrate) 42, and may be disposed on the housing 40 via the second substrate 42. In an example embodiment, the second substrate 42 may be disposed on an external surface of the housing 40, and the housing 40 may include a through-hole 402 penetrating through a side surface of the housing 40, such that the second driving coil 223 may oppose the second driving magnet 221 through the through-hole 402.

The second driving magnet 221 may be magnetized such that a surface thereof opposing the second driving coil 223 has an N-pole and an S-pole. For example, a surface of the second driving magnet 221, opposing the second driving coil 223, may sequentially include an N-pole, a neutral region, and an S-pole (or an S-Pole, a neutral region, and an N-pole) in the optical axis direction (Z-axis direction).

When power is applied to the second driving coil 223, the second driving magnet 221 and the second driving coil 223 may generate driving force in the optical axis direction (Z-axis direction).

The carrier 21 may move in the optical axis direction (Z-axis direction) by the driving force generated by the second driving magnet 221 and the second driving coil 223. The lens module 10 may be coupled to the carrier 21, such that the lens module 10 may also move in the optical axis direction together with the carrier 21. As the lens module 10 moves in the optical axis direction (Z-axis direction), focus of the camera module 1 may be adjusted.

A position sensor 225, sensing a position of the carrier 21 in the optical axis direction (Z-axis direction), may be disposed on the second substrate 42. For example, the position sensor 225 may be a Hall sensor, and may be disposed to oppose the second driving magnet 221.

A plurality of ball members 23 may be disposed between the carrier 21 and the housing 40. The plurality of ball members 23 may guide movement of the carrier 21 in the optical axis direction (Z-axis direction), and may reduce friction during movement in the optical axis direction (Z-axis direction).

The plurality of ball members 23 may include a first ball member 231, a second ball member 232, and a third ball member 233.

Referring to FIG. 15, the plurality of ball members 23 may be disposed not to overlap each other in the optical axis direction (Z-axis direction). For example, the first ball member 231, the second ball member 232, and the third ball member 233 may be spaced apart from each other in a second direction (X-direction). The first ball member 231, the second ball member 232, and the third ball member 233 may guide movement of the carrier 21 in the optical axis direction (Z-axis direction) while performing rolling motion in the optical axis direction (Z-axis direction).

The second driving magnet 221 and the second driving coil 223 may be disposed between the plurality of ball members 23. For example, the first ball member 231 and the second ball member 232 may be disposed to be spaced apart from one side of the second driving magnet 221 in a length direction and one side of the second driving coil 223 in the length direction, and the third ball member 233 may be disposed to be spaced apart from the other side of the second driving magnet 221 in the length direction and the other side of the second driving coil 223 in the length direction. The first ball member 231 may be disposed to be adjacent to the one side of the second driving magnet 221 in the length direction and the one side of the second driving coil 223 in the length direction, and the second ball member 232 may be disposed to be adjacent to the first ball member 231. A separation distance between the first ball member 231 and the second ball member 232 in the second direction (X-direction) may be less than a separation distance between the first ball member 231 and the third ball member 233 in the second direction (X-direction).

The plurality of ball members 23 may be individually accommodated in guide groove portions formed between the carrier 21 and the housing 40.

The first ball member 231 may be accommodated in a first guide groove portion G1 formed by a first guide groove g1 formed in the carrier 21 and a second guide groove g2 formed in the housing 40. The first guide groove g1 and the second guide groove g2 may each have a form extending in the optical axis direction (Z-axis direction), and may oppose each other in the first direction (Y-direction). The second ball member 232 may be accommodated in a second guide groove portion G2 formed by a third guide groove g3 formed in the carrier 21 and a fourth guide groove g4 formed in the housing 40. The third guide groove g3 and the fourth guide groove g4 may each have a form extending in the optical axis direction (Z-axis direction), and may oppose each other in the first direction (Y-direction). The third ball member 233 may be accommodated in a third guide groove portion G3 formed by a fifth guide groove g5 formed in the carrier 21 and a sixth guide groove g6 formed in the housing 40. The fifth guide groove g5 and the sixth guide groove g6 may each have a form extending in the optical axis direction (Z-axis direction), and may oppose each other in the first direction (Y-direction).

The first ball member 231 may be in contact with the first guide groove portion G1 at four points. For example, the first ball member 231 may form two contact points with each of the first guide groove g1 and the second guide groove g2. Similarly, the second ball member 232 may also be in contact in the second guide groove portion G2 at four points. The second ball member 232 may form two contact points with each of the third guide groove g3 and the fourth guide groove g4.

The third ball member 233 may be in contact in the third guide groove portion G3 at three points. The third ball member 233 may form two contact points with the fifth guide groove g5 and one contact point with the sixth guide groove g6 (or one contact point with the fifth guide groove g5 and two contact points with the sixth guide groove g6).

The first ball member 231 and the second ball member 232 may correspond to main guides guiding movement of the carrier 21 in the optical axis direction (Z-axis direction), and the third ball member 233 may correspond to an auxiliary guide supporting movement of the carrier 21 in the optical axis direction (Z-axis direction).

The camera module 1 according to an example embodiment of the present disclosure may have a structure in which the main guides are separated into two positions, thereby reducing a height of the camera module 1 in the optical axis direction (Z-axis direction).

A first yoke 227 may be disposed on the housing 40. The first yoke 227 may be disposed to oppose the second driving magnet 221. For example, the first yoke 227 may be disposed on the second substrate 42, a second driving coil 223 may be disposed on one surface of the second substrate 42, and the first yoke 227 may be disposed on the other surface of the second substrate 42.

The first yoke 227 may be formed of a magnetic material, and the first yoke 227 and the second driving magnet 221 may generate attractive force therebetween. The first yoke 227 and the second driving magnet 221 may generate the attractive force in a direction in which the first yoke 227 and the second driving magnet 221 oppose each other, for example, in the first direction (Y-direction). By the attractive force between the first yoke 227 and the second driving magnet 221, the plurality of ball members 23 may maintain a contact state with the carrier 21 and the housing 40.

To prevent the occurrence of tilt of the carrier 21, the camera module 1 may further include a third magnet 241 and a second yoke 247.

The second yoke 247 may be formed of a magnetic material, and the second yoke 247 and the third magnet 241 may generate attractive force therebetween. The second yoke 247 and the third magnet 241 may generate the attractive force in a direction in which the second yoke 247 and the third magnet 241 oppose each other, for example, in the first direction (Y-direction).

The third magnet 241 may be disposed on the carrier 21, and the second yoke 247 may be disposed on the housing 40 to oppose the third magnet 241. However, positions of the third magnet 241 and the second yoke 247 may be interchanged.

The third magnet 241 may be disposed to be spaced apart from the second driving magnet 221 with the first ball member 231 and the second ball member 232 interposed therebetween. For example, in a circumferential direction of the carrier 21, the second driving magnet 221, the first ball member 231, the second ball member 232, and the third magnet 241 may be sequentially disposed.

In an example embodiment, resultant force of attractive force (first attractive force) acting between the second driving magnet 221 and the first yoke 227 and attractive force (second attractive force) acting between the third magnet 241 and the second yoke 247 may act closer to the first ball member 231 and the second ball member 232 than to the third ball member 233. That is, since the resultant force of the first attractive force and the second attractive force may act closer to the main guides than to the auxiliary guide, the carrier 21 may be stably driven.

The carrier 21 may be supported by the housing 40 with the plurality of ball members 23 interposed therebetween, and may move in the optical axis direction (Z-axis direction).

The carrier 21 may be supported by the first ball member 231, the second ball member 232, and the third ball member 233 at three points, and a center of the attractive forces (the resultant force of the first attractive force and the second attractive force) may be positioned in a support region connecting the three support points.

At least one of the first ball member 231, the second ball member 232, and the third ball member 233 may be disposed at a different position in the optical axis direction (Z-axis direction). In an example embodiment, the first ball member 231 and the second ball member 232, the main guides, may be disposed at different positions in the optical axis direction (Z-axis direction), and the third ball member 233, the auxiliary guide, may be disposed at a position same as that of the first ball member 231 or the second ball member 232 in the optical axis direction (Z-axis direction). The third ball member 233 may be disposed at a position the same as that of the second ball member 232 in the optical axis direction (Z-axis direction) and disposed at a position farther spaced apart from the second driving magnet 221.

The housing 40 may include a plurality of support portions protruding from a bottom surface of the housing 40 in the optical axis direction (Z-axis direction) such that the first ball member 231, the second ball member 232, and the third ball member 233 may be disposed at the above-described positions.

The plurality of support portions may be disposed in guide grooves formed in the housing 40, for example, in the second guide groove g2, the fourth guide groove g4, and the sixth guide groove g6.

The plurality of support portions may include a first support portion 431 protruding from the bottom surface of the housing 40 toward the first ball member 231, a second support portion 432 protruding toward the second ball member 232, and a third support portion 433 protruding toward the third ball member 233. In an example embodiment, a length of the first support portion 431 in the optical axis direction (Z-axis direction) may be greater or less than a length of the second support portion 432 in the optical axis direction (Z-axis direction), and a length of the second support portion 432 in the optical axis direction (Z-axis direction) may be equal to a length of the third support portion 433 in the optical axis direction (Z-axis direction).

Although the present specification has been described mainly with reference to an example embodiment in which the camera module 1 includes only the lens driving unit 20 driving the lens module 10 in the optical axis direction (Z-axis direction), as described above, the camera module 1 may further include a lens driving unit driving the lens module 10 in a direction perpendicular to the optical axis (Z-axis). In addition, although the present specification and the drawings attached hereto describe and illustrate the carrier 21 of the camera module 1 as having a cylindrical shape, a shape of the carrier 21 is not limited thereto.

According to example embodiments of the present disclosure as described herein, an aperture module may be manufactured to have a small size and small thickness, and thus may be applied to a camera module of a portable electronic device.

In particular, the aperture module according to example embodiments of the present disclosure as described herein may be manufactured to have a size less than a size of a lens barrel of the camera module, thereby preventing an increase in a volume of the camera module due to the aperture module.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An aperture module comprising:
a plurality of blades disposed on a lens barrel, the plurality of blades forming an incident hole;
a driving link on which a magnet is disposed, the driving link configured to be rotatable; and
a coil disposed to oppose the magnet,
wherein the lens barrel has a first outer diameter and a second outer diameter, and
wherein a rotation axis of the driving link is disposed between the first outer diameter and the second outer diameter of the lens barrel.

2. The aperture module of claim 1, wherein
the plurality of blades comprise rotation axes, and
one blade, among the plurality of blades, shares a rotation axis with the driving link.

3. The aperture module of claim 2, wherein the rotation axes of the plurality of blades are disposed between the first outer diameter and the second outer diameter of the lens barrel.

4. The aperture module of claim 3, wherein the first outer diameter of the lens barrel is a minimum outer diameter of the lens barrel, and the second outer diameter of the lens barrel is a maximum outer diameter of the lens barrel.

5. The aperture module of claim 2, wherein the plurality of blades comprise three or more blades.

6. The aperture module of claim 5, wherein the blade sharing the rotation axis with the driving link, among the plurality of blades, is integrally formed with the driving link.

7. The aperture module of claim 2, wherein
the plurality of blades comprise:
a first blade and a second blade comprising rotation axes different from that of the driving link; and
a third blade comprising a rotation axis the same as that of the driving link, and
the third blade is coupled to the first blade and the second blade.

8. The aperture module of claim 7, wherein
the first blade and the second blade comprise guide slits penetrating through the first blade and the second blade in the optical axis direction, respectively, and
the third blade comprises guide protrusions protruding in the optical axis direction, the guide protrusions disposed to respectively penetrate through the guide slits.

9. The aperture module of claim 8, wherein
the plurality of blades further comprise an auxiliary blade disposed to overlap the first blade, the second blade, and the third blade in the optical axis direction, and
the auxiliary blade comprises coupling holes to which the guide protrusions disposed to penetrate through the guide slits are coupled.

10. The aperture module of claim 1, wherein the driving link extends in an optical axis direction, and is disposed at a distance from the lens barrel in a direction perpendicular to an optical axis.

11. The aperture module of claim 10, wherein at least a portion of the driving link is bent along a shape of the lens barrel.

12. The aperture module of claim 1, further comprising:
a base to which the plurality of blades and the driving link are coupled,
wherein the base is coupled to the lens barrel.

13. The aperture module of claim 12, wherein
the lens barrel comprises a minimum outer diameter on an object side thereof, and
the base comprises a ring shape, and is coupled to an outer circumferential surface having the minimum outer diameter of the lens barrel.

14. A camera module comprising:
a housing;
a carrier accommodated in the housing, the carrier configured to move in an optical axis direction;
the lens barrel comprising a plurality of lenses, the lens barrel coupled to the carrier; and
the aperture module of claim 1,
wherein the coil is disposed on the housing.

15. The camera module of claim 14, wherein
the driving link extends in the optical axis direction along the lens barrel, and
the magnet is disposed between the carrier and the housing to oppose the coil in a direction perpendicular to an optical axis.

16. The camera module of claim 15, wherein the driving link is disposed to be spaced apart from the lens barrel and the carrier in the direction perpendicular to the optical axis.

17. The camera module of claim 16, wherein the carrier comprises a groove on an external surface thereof, and the magnet is disposed in the groove.

18. The camera module of claim 17, further comprising:
a ball bearing disposed between the carrier and the magnet.

19. The camera module of claim 14, further comprising:
a focus adjustment magnet disposed on the carrier; and
a focus adjustment coil disposed on the housing to oppose the focus adjustment magnet.

20. The camera module of claim 14, wherein
the plurality of blades comprise rotation axes,
the rotation axes of the plurality of blades are disposed between a first outer diameter and a second outer diameter of the lens barrel, and
one blade, among the plurality of blades, shares a rotation axis with the driving link.

21. The camera module of claim 20, wherein the first outer diameter of the lens barrel is a minimum outer diameter of the lens barrel, and the second outer diameter of the lens barrel is a maximum outer diameter of the lens barrel.

22. The camera module of claim 20, wherein
the plurality of blades comprise:
a first blade and a second blade comprising rotation axes different from that of the driving link; and
a third blade comprising a rotation axis the same as that of the driving link, and
the third blade is coupled to the first blade and the second blade.

23. The camera module of claim 14, further comprising:
a cap coupled to the lens barrel configured to cover the plurality of blades.

24. An aperture module comprising:
a plurality of blades forming an incident hole;
a driving link extending in an optical axis direction;
a magnet disposed on the driving link; and
a coil disposed to oppose the magnet,
wherein the plurality of blades and the driving link are configured to rotate about rotation axes by driving force generated by the magnet and the coil, and
wherein one blade, among the plurality of blades, shares a rotation axis with the driving link.

25. The aperture module of claim 24, wherein
the plurality of blades and the driving link are disposed on a lens barrel, and
the rotation axes of the plurality of blades and the driving link are disposed between a first outer diameter and a second outer diameter of the lens barrel.

26. The aperture module of claim 25, wherein the first outer diameter of the lens barrel is a minimum outer diameter of the lens barrel, and the second outer diameter of the lens barrel is a maximum outer diameter of the lens barrel.

27. The aperture module of claim 24, wherein the magnet and the coil are disposed to oppose each other in a first direction perpendicular to the optical axis direction, and generate driving force in a second direction perpendicular to both the optical axis direction and the first direction.

28. The aperture module of claim 27, wherein the driving link is disposed at a distance from the lens barrel in a direction perpendicular to an optical axis.

29. The aperture module of claim 24, wherein
the plurality of blades comprise:
a first blade and a second blade comprising rotation axes different from that of the driving link; and
a third blade comprising a rotation axis the same as that of the driving link, and
the third blade is coupled to the first blade and the second blade.

30. The aperture module of claim 24, wherein the blade sharing the rotation axis with the driving link, among the plurality of blades, is integrally formed with the driving link.

31. An aperture module comprising:
a plurality of blades each disposed on a separate rotation axis, and forming an incident hole; and
a driving link configured to be rotatable and sharing a same rotation axis as a blade of the plurality of blades,
wherein the blade sharing the same rotation axis as the driving link is coupled to at least a first blade and a second blade of the plurality of blades, and
wherein the plurality of blades are configured to rotate in response to rotation of the driving link.

32. The aperture module of claim 31, further comprising:
a magnet disposed on the driving link; and
a coil disposed to oppose the magnet,
wherein the magnet and the coil are configured to generate a driving force to rotate the driving link.

33. The aperture module of claim 31, wherein a lens barrel has a first outer diameter and a second outer diameter, and
wherein the rotation axis of the driving link is disposed between the first outer diameter and the second outer diameter of the lens barrel.
